(19) United States
(12) Patent Application Publication
(10) Pub. No.: US 2011/0137831 A1
(43) Pub. Date: Jun. 9, 2011

(54) LEARNING APPARATUS, LEARNING METHOD AND PROGRAM

(76) Inventors: Naoki IDE, Tokyo (JP); Masato Ito, Tokyo (JP); Kohtaro Sabe, Tokyo (JP)

(21) Appl. No.: 12/917,853

(22) Filed: Nov. 2, 2010

(30) Foreign Application Priority Data
Dec. 4, 2009 (JP) P2009-276691

(51) Int. Cl. G06F 15/18

(52) U.S. Cl. 706/12

(57) ABSTRACT

A learning apparatus includes: an interpolating section which interpolates data missing in time series data; an estimating section which estimates a Hidden Markov Model from the time series data; and a likelihood calculating section which calculates the likelihood of the estimated Hidden Markov Model. The likelihood calculating section calculates the likelihood for normal data which does not have missing data and the likelihood for interpolation data which is interpolated data in different conditions and calculates the likelihood of the Hidden Markov Model for the time series data in which the data is interpolated. The estimating section updates the Hidden Markov Model so that the likelihood calculated by the likelihood calculating section becomes high.

### BACKGROUND OF THE INVENTION

1. Field of the Invention

The present invention relates to a learning apparatus, a learning method and a program, and more particularly, to a learning apparatus, a learning method and a program which learn an activity state of a user as a Hidden Markov Model from time series data.

2. Description of the Related Art

In recent years, research has been actively pursued for modeling, for learning, a state of a user using time series data obtained from a wearable sensor which is a sensor which the user can wear on the body and recognizing a current state of the user using the model obtained by the learning (for example, Japanese Unexamined Patent Application Publication No. 2006-134080, Japanese Unexamined Patent Application Publication No. 2008-204040, and “Life Patterns: structure from wearable sensors”, Brian Patrick Clarkson, Doctor Thesis, MIT, 2002).

Further, the present applicant has previously proposed a method of probabilistically predicting a plurality of possibilities of an activity state of a user in a desired future time as Japanese Patent Application No. 2009-180780. In the method of Japanese Patent Application No. 2009-180780, it is possible to learn the activity state of the user from time series data as a probabilistic state transition model, to recognize a current activity state using the learned probabilistic state transition model, and to probabilistically predict the activity state of the user “after a predetermined time”. Also, as an example of the prediction of the activity state of the user “after the predetermined time”, Japanese Patent Application No. 2009-180780 discloses an example which recognizes a current location of the user and predicts a destination (location) of the user after the predetermined time.

In addition, the present applicant has previously proposed a method of predicting arrival probabilities, paths and arrival times for a plurality of destinations and a method of automatically detecting destination candidates as Japanese Patent Application No. 2009-208064. In the method of Japanese Patent Application No. 2009-208064, it is possible to search a state node corresponding to a destination from among state nodes forming a probabilistic state transition model.

### SUMMARY OF THE INVENTION

In the methods of Japanese Patent Application No. 2009-180780 and Japanese Patent Application No. 2009-208064, there is disclosed an example which learns an activity state of a user as a Hidden Markov Model from time series data on locations (latitude and longitude) measured by a GPS sensor.

The Hidden Markov Model in this case is a probability model which expresses, from time series data sensed at an equivalent interval, dynamics of parameters “hidden” behind the time series data as a probabilistic transition of states. In this way, in a case where the Hidden Markov Model is learned from the time series data, the used time series data is preferably data sampled at an equivalent interval.

On the other hand, the GPS sensor is a sensor which acquires a signal from a satellite and measures the latitude and longitude of a current location. Thus, the GPS sensor is difficult to measure the latitude and longitude of the current location such as under the ground or inside a building which the signal from the satellite does not reach. Further, a missing period occurs in the time series data on the locations (latitude and longitude) from the time when the GPS sensor is difficult to measure the latitude and longitude to the time when the measurement is re-started.

The Hidden Markov Model learning can be performed even using the time series data in which a missing period occurs in this way. However, in a model obtained in this case, a state transition appears in which a corresponding state node before the missing period and a corresponding state node after the missing period are discontinuous each other.

For example, FIG. 1 illustrates a result obtained by learning commuting paths as the Hidden Markov Model from time series data obtained by measuring locations over 10 days by the GPS sensor when an experimenter commutes from the residence to the office by train, by the learning method disclosed in Japanese Patent Application No. 2009-208064. In the figure, a small circle represents a location of each state node of the learned Hidden Markov Model. Further, a straight line connecting the respective state nodes represents a state transition between the state nodes. In FIG. 1, the horizontal axis represents the longitude, and the vertical axis represents the latitude.

FIG. 2 is a diagram indicating locations and names of respective stations in FIG. 1 so that the positional relation between the respective stations on a routine used for commuting can be seen.

Since this routine passes under the ground from the vicinity of the NAGAHARA station to the vicinity of the EBARA-NAKANOBU station, a missing portion in time series data occurs in the vicinities thereof. For this reason, for example, data in which the vicinity of the SENZOKU-IKE station and the vicinity of the HATANODAI station, the vicinity of the HATANODAI station and the vicinity of the TOGOSHIGINJA station, the vicinity of the SENZOKU-IKE station and the vicinity of the EBARA-NAKANOBU station, and the vicinity of the SENZOKU-IKE station and the vicinity of the OSAKIHIROKOJI station are respectively discontinuous with each other appears as time series data. Thus, if a learning process is performed using this time series data, a model including state transitions (that is, paths) directly connecting state nodes of the vicinity of the SENZOKU-IKE station and the vicinity of the HATANODAI station, the vicinity of the HATANODAI station and the vicinity of the TOGOSHIGINJA station, the vicinity of the SENZOKU-IKE station and the vicinity of the EBARA-NAKANOBU station, and the vicinity of the SENZOKU-IKE station and the vicinity of the OSAKIHIROKOJI station, respectively, is learned.

For example, in a case where an arrival time at a destination is predicted using the model learned in this way, a warped section appears on the path to the destination. Thus, the number of the state nodes (hereinafter, referred to as step number) which are transited until arrival at the destination becomes smaller than an actual value, and the prediction accuracy of the arrival time at the destination is deteriorated.

Further, a normal path and a discontinuous path exist with respect to the same path, which are respectively recognized as branch paths. In addition, in a case where a location in which the time series data is missing is not constant, a different discontinuous path is learned in accordance with the location in which the time series data is missing, and as a result, a large number of branch paths appears in the learned model. Consequently, in a case where the path to the destination is searched, a plurality of branch paths which does not actually exist should be searched, which increases a load applied to the process, lengthens the process time and lowers the reliability of the process result.

Accordingly, it is desirable to provide a technique which is capable of more accurately learning the Hidden Markov Model from the time series data in which the missing data occurs.

According to an embodiment of the present invention, there is provided a learning apparatus including: interpolating means for interpolating data missing in time series data; estimating means for estimating a Hidden Markov Model from the time series data; and likelihood calculating means for calculating the likelihood of the estimated Hidden Markov Model, wherein the likelihood calculating means calculates the likelihood for normal data which does not have missing data and the likelihood for interpolation data which is interpolated data in different conditions and calculates the likelihood of the Hidden Markov Model for the time series data in which the data is interpolated, and wherein the estimating means updates the Hidden Markov Model so that the likelihood calculated by the likelihood calculating means becomes high.

According to another embodiment of the present invention, there is provided a learning method performed in a learning apparatus which learns a Hidden Markov Model from time series data, the method including the steps of: interpolating data missing in the time series data; estimating the Hidden Markov Model from the time series data; calculating the likelihood of the estimated Hidden Markov Model; calculating the likelihood for normal data which does not have missing data and the likelihood for interpolation data which is interpolated data in different conditions and calculating the likelihood of the Hidden Markov Model for the time series data in which the data is interpolated, and updating the Hidden Markov Model so that the calculated likelihood becomes high.

According to still another embodiment of the present invention, there is provided a program which causes a procedure to be executed in a computer, the procedure including the steps of: interpolating data missing in the time series data; estimating the Hidden Markov Model from the time series data; calculating the likelihood of the estimated Hidden Markov Model; calculating the likelihood for normal data which does not have missing data and the likelihood for interpolation data which is interpolated data in different conditions and calculating the likelihood of the Hidden Markov Model for the time series data in which the data is interpolated, and updating the Hidden Markov Model so that the calculated likelihood becomes high.

According to such an embodiment, the missing data in the time series data is interpolated, the Hidden Markov Model is estimated from the time series data, the likelihood of the estimated Hidden Markov Model is calculated; the likelihood for the normal data which does not have the missing data and the likelihood for the interpolation data which is the interpolated data are calculated in different conditions; the likelihood of the Hidden Markov Model for the time series data in which the data is interpolated is calculated; and the Hidden Markov Model is updated so that the calculated likelihood becomes high.

According to an embodiment of the present invention, it is possible to more accurately learn the Hidden Markov Model from the missing time series data.

### BRIEF DESCRIPTION OF THE DRAWINGS

FIG. 1 is a diagram illustrating a learning result of a Hidden Markov Model in the related art.

FIG. 2 is a diagram illustrating a learning result of a Hidden Markov Model in the related art.

FIG. 3 is a block diagram illustrating a configuration example of a prediction system according to an exemplary embodiment of the present invention.

FIG. 4 is a block diagram illustrating an example of a functional configuration of a behavior learning section.

FIG. 5 is a block diagram illustrating a hardware configuration example of a prediction system.

FIG. 6 is a diagram illustrating an example of time series data input to a prediction system.

FIG. 7 is a diagram illustrating an example of an HMM.

FIG. 8 is a diagram illustrating an example of an HMM used for sound recognition.

FIGS. 9A and 9B are diagrams illustrating an example of an HMM which is given a sparse restriction.

FIG. 10 is a diagram illustrating a simple example of a search process of a path by means of a behavior predicting section.

FIG. 11 is a flowchart illustrating a user activity model learning process.

FIG. 12 is a flowchart illustrating a parameter updating process.

FIG. 13 is a flowchart illustrating a data interpolation process.

FIG. 14 is a flowchart illustrating an arrival time prediction process.

FIG. 15 is a diagram illustrating a specific example of effects of the present invention.

FIG. 16 is a diagram illustrating a learning result of a Hidden Markov Model according to a first method which is different from the present invention.

FIG. 17 is a diagram illustrating a learning result of a Hidden Markov Model according to a second method which is different from the present invention.

FIG. 18 is a diagram illustrating a learning result of a Hidden Markov Model according to a second method which is different from the present invention.

FIG. 19 is a block diagram illustrating a computer to which an exemplary embodiment of the present invention is applied.

### DESCRIPTION OF THE PREFERRED EMBODIMENTS

Hereinafter, exemplary embodiments for carrying out the present invention will be described. That is, the description will be made in the following order:

1. Embodiment

2. Modified example

### 1. Embodiment

### Block Diagram Illustrating Prediction System According to Embodiment

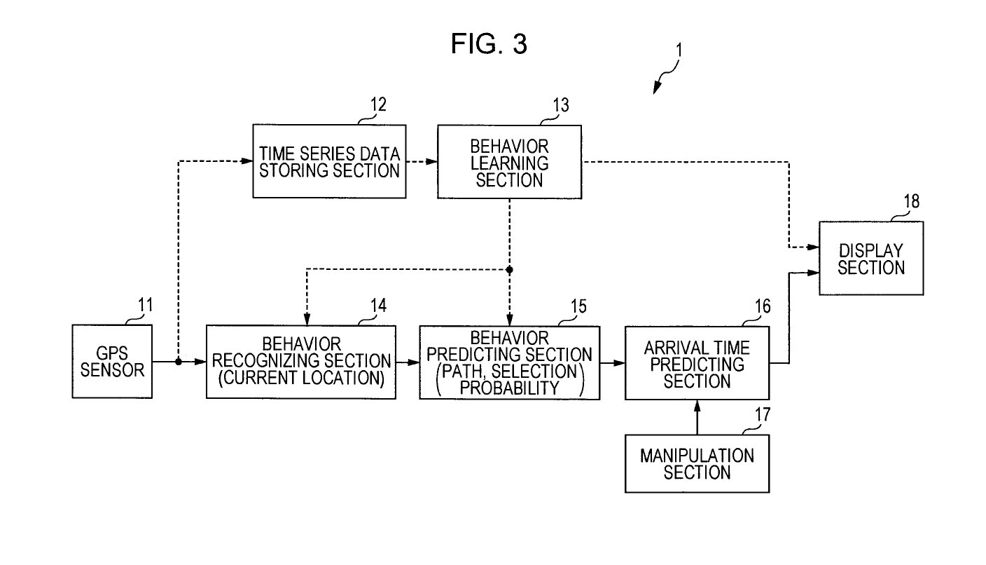

FIG. 3 is a block diagram illustrating a configuration example of a prediction system according to an exemplary embodiment of the present invention.

The prediction system 1 includes a GPS sensor 11, a time series data storing section 12, a behavior learning section 13, a behavior recognizing section 14, a behavior predicting section 15, an arrival time predicting section 16, a manipulation section 17 and a display section 18.

The prediction system 1 performs a learning process for learning an activity state (a state indicating a behavior and an activity pattern) of a user as a probabilistic state transition model, using time series data indicating a current location and a current time acquired by the GPS sensor 11. Further, the prediction system 1 performs a prediction process for predicting a path and a time up to a destination designated by the user, using the probabilistic state transition model (user activity model) indicated by parameters obtained by a learning process.

In FIG. 3, a dotted arrow represents a flow of data in the learning process and a solid arrow represents a flow of data in the prediction process.

The GPS sensor 11 receives signals from a satellite at predetermined time intervals (for example, 15 seconds), and then measures the latitude and longitude of a current location of the user. Further, in the learning process, the GPS sensor 11 supplies data (hereinafter, referred to as GPS data) on the measured locations (latitude and longitude) and the measured times (hereinafter, referred to as measured times) to the time series data storing section 12. Further, in the prediction process, the GPS sensor 11 supplies the GPS data to the behavior recognizing section 14.

The time series data storing section 12 stores the GPS data continuously acquired by the GPS sensor 11, that is, the time series data on the locations and measured times. Since a behavior and an activity pattern of a user are learned, for example, time series data stored for a certain period such as several days are necessary.

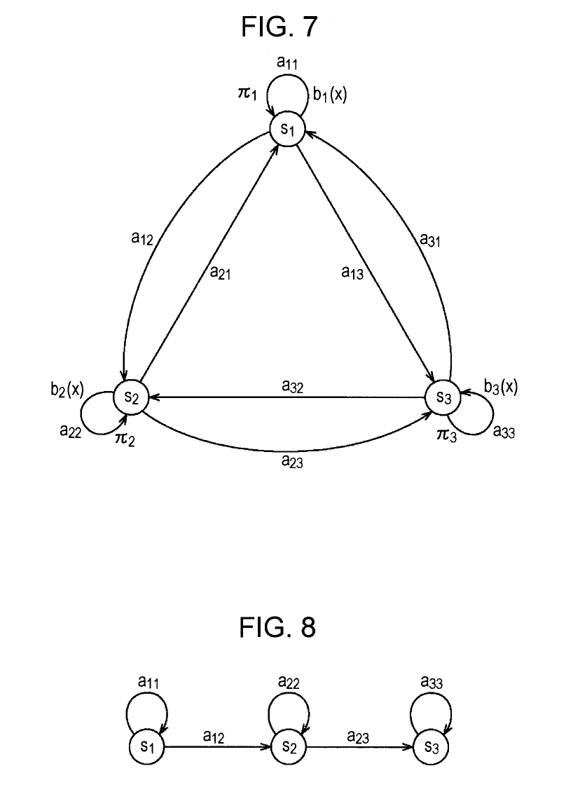

The behavior learning section 13 learns an activity state of a user who carries a device provided with the GPS sensor 11 as the probabilistic state transition model, on the basis of the time series data stored in the time series data storing section 12. Since the time series data indicates the locations of the user and the measured times, the activity state of the user learned as the probabilistic state transition model represents a time series change in a current location of the user, that is, a movement path of the user. As the probabilistic state transition model used for learning, for example, a probabilistic state transition model including a hidden state, such as an ergodic HMM (Hidden Markov Model) or the like, can be employed. In this embodiment, a probabilistic state transition model in which a sparse restriction is given to the ergodic HMM is employed as the probabilistic sate transition model. A calculation method of the ergodic HMM having the sparse restriction and parameters of the ergodic HMM, or the like will be described later with reference to FIGS. 7 to 9.

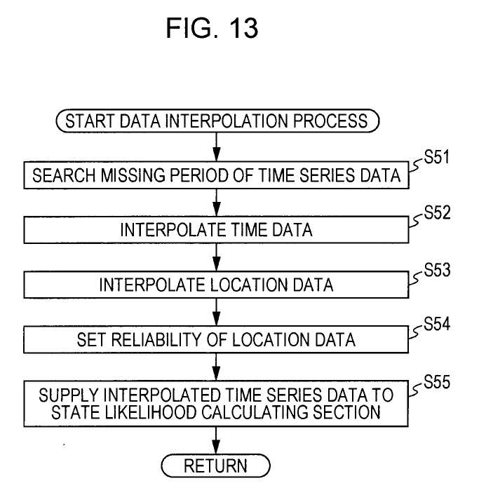

Further, as described above, in a case where the GPS sensor 11 is not able to measure the current location, a missing period is generated in the time series data. In this case, the behavior learning section 13 interpolates data missing in the time series data as described later with reference to FIG. 13, and learns the activity state of the user.

The behavior learning section 13 supplies the data indicating a learning result to the display section 18 for display. The behavior learning section 13 supplies parameters of the probabilistic state transition model obtained by the learning process to the behavior recognizing section 14 and the behavior predicting section 15.

The behavior recognizing section 14 recognizes a current behavior state of the user, that is, a current location of the user, from the time series data on the locations supplied in real time from the GPS sensor 11, using the probabilistic state transition model of the parameters obtained through learning. The behavior recognizing section 14 supplies a node number of a current state node of the user to the behavior predicting section 15.

The behavior predicting section 15 proportionately searches (predicts) paths which can be taken by the user from the current location of the user indicated by the node number of the state node supplied from the behavior recognizing section 14, using the probabilistic state transition model of the parameters obtained through learning. Further, the behavior predicting section 15 calculates an occurrence probability for each searched path to predict a selection probability which is a probability that the searched path is selected.

The path which can be taken by the user from the behavior predicting section 15 and the selection probability thereof are supplied to the arrival time predicting section 16. Further, information indicating a destination designated by the user through the manipulation section 17 is supplied to the arrival time predicting section 16.

The arrival time predicting section 16 extracts paths including the destination designated by the user from the paths which can be taken by the user as the search result, and predicts an arrival time up to the destination for each extracted path. Further, the arrival time predicting section 16 predicts an arrival probability which is a probability that the user reaches the destination. In a case where a plurality of paths exists for the destination, the arrival time predicting section 16 calculates the sum of the selection probabilities of the plurality of paths as the arrival probability for the destination. In a case where only one path exists for the destination, the selection probability of the path becomes the arrival probability for the destination. Thus, the arrival time predicting section 16 supplies information indicating the prediction result to the display section 18 for display.

The manipulation section 17 receives information about the destination input by the user and supplies the information to the arrival time predicting section 16. The display section 18 displays the information supplied from the behavior learning section 13 or the arrival time predicting section 16.

### [Example of Functional Configuration of Behavior Learning Section]

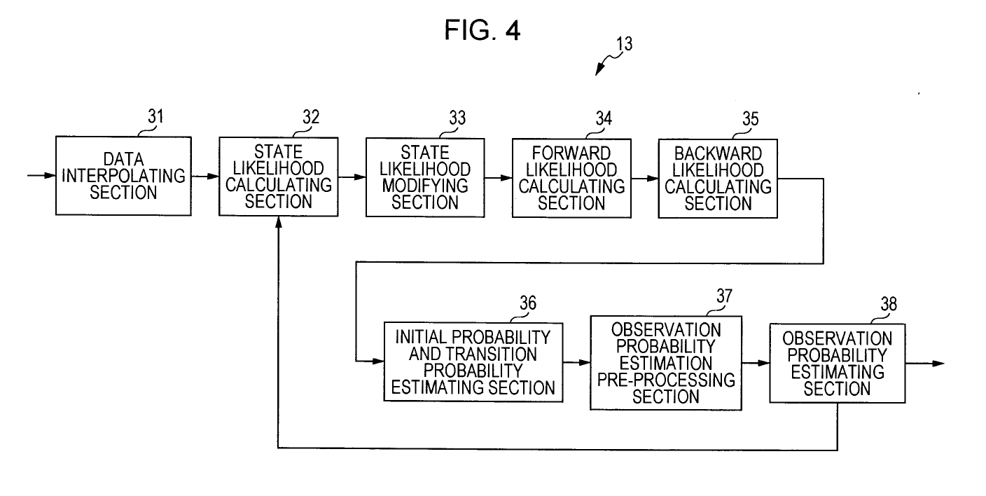

FIG. 4 is a block diagram illustrating an example of a functional configuration of the behavior learning section 13 of the prediction system 1.

The behavior learning section 13 includes a data interpolating section 31, a state likelihood calculating section 32, a state likelihood modifying section 33, a forward likelihood calculating section 34, a backward likelihood calculating section 35, an initial probability and transition probability estimating section 36, an observation probability estimation pre-processing section 37 and an observation probability estimating section 38.

The data interpolating section 31 obtains the time series data stored in the time series data storing section 12, and interpolates data of the time series data in the missing period, as described later with reference to FIG. 13. The data interpolating section 31 supplies the time series data after interpolation to the state likelihood calculating section 32.

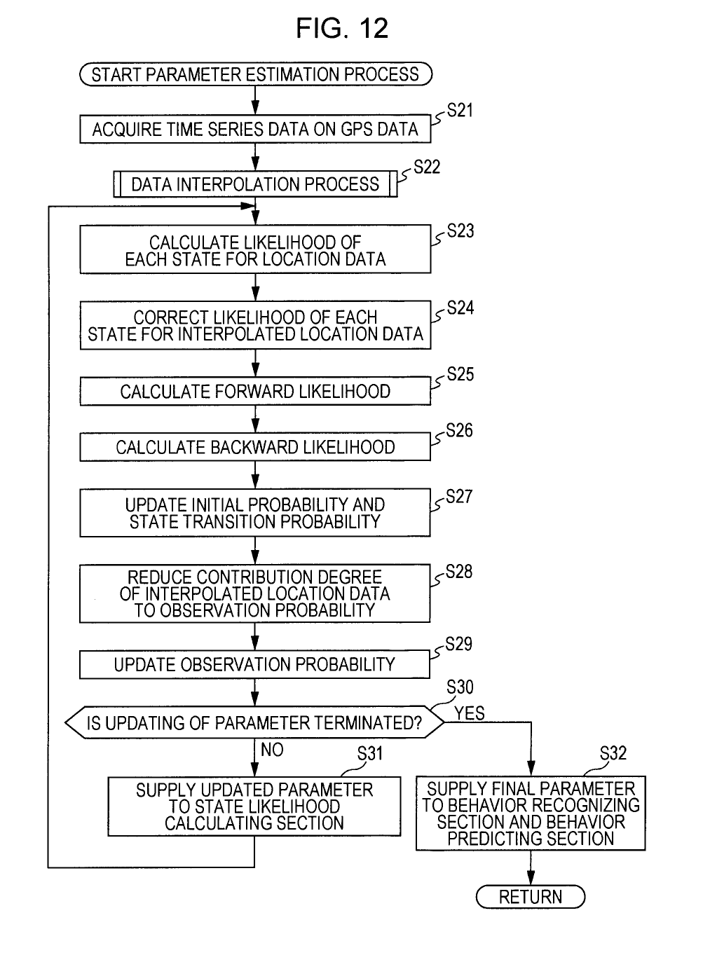

The state likelihood calculating section 32 calculates the likelihood (hereinafter, referred to as state likelihood) for the time series data on respective states of an HMM indicating an activity model of the user, as described later with reference to FIG. 12. The state likelihood calculating section 32 supplies data indicating the calculated state likelihood and the time series data to the state likelihood modifying section 33.

The state likelihood modifying section 33 modifies the state likelihood for the time series data in the missing period, as described later with reference to FIG. 12, and supplies data indicating the modified state likelihood, and the time series data to the forward likelihood calculating section 34.

The forward likelihood calculating section 34 calculates a forward likelihood for the time series data of the HMM indicating the activity model of the user, as described later with reference to FIG. 12. The forward likelihood calculating section 34 adds data indicating the calculated forward likelihood to the data acquired from the state likelihood modifying section 33, and then supplies it to the backward likelihood calculating section 35.

The backward likelihood calculating section 35 calculates a backward likelihood for the time series data of the HMM indicating the activity model of the user, as described later with reference to FIG. 12. The backward likelihood calculating section 35 adds data indicating the calculated backward likelihood to the data acquired from the forward likelihood calculating section 34, and then supplies it to the initial probability and transition probability estimating section 36.

The initial probability and transition probability estimating section 36 estimates an initial probability and an state transition probability of the HMM indicating the activity model of the user, as described later with reference to FIG. 12. The initial probability and transition probability estimating section 36 adds data indicating the calculated initial probability and the state transition probability to the data acquired from the backward likelihood calculating section 35, and then supplies it to the observation probability estimation pre-processing section 37.

Before estimating the observation probability of the HMM indicating the activity of the user, the observation probability estimation pre-processing section 37 changes the forward likelihood and the backward likelihood for the time series data in the missing period, as described later with reference to FIG. 12. The observation probability estimation pre-processing section 37 supplies data, in which the forward likelihood and the backward likelihood are changed with respect to the data acquired from the initial probability and transition probability estimating section 36, to the observation probability estimating section 38.

The observation estimating section 38 estimates the initial probability of the HMM indicating the activity model of the user, as described later with reference to FIG. 12. The observation estimating section 38 supplies data indicating parameters (initial probability, state transition probability, and observation probability) of the HMM to the behavior recognizing section 14 and the behavior predicting section 15, or the state likelihood calculating section 32.

### [Example of Hardware Configuration of Prediction System]

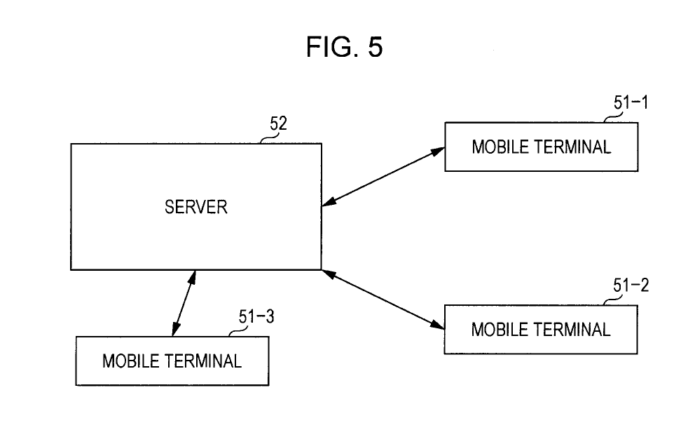

The prediction system 1 with such a configuration can employ a hardware configuration shown in FIG. 5, for example. That is, FIG. 5 is a block diagram illustrating the hardware configuration example of the prediction system 1.

In FIG. 5, the prediction system 1 includes three mobile terminals 51-1 to 51-3, and a server 52. The mobile terminals 51-1 to 51-3 are the same type mobile terminals 51 having the same function, but the mobile terminals 51-1 to 51-3 are possessed by different users. Only three mobile terminals 51-1 to 51-3 are shown in FIG. 5, but in reality, the number of the mobile terminals 51 may correspond to the number of users.

The mobile terminals 51 can perform transmission and reception of data to/from the server 52 by communication through a network such as a wireless communication network and the internet. The server 52 receives the data transmitted from the mobile terminals 51 and performs a predetermined process for the received data. Further, the server 52 transmits the process result of the data processing to the mobile terminals 51 by wireless communication or the like.

Accordingly, the mobile terminals 51 and the server 52 have a communication section which performs communication in a wireless or wired manner.

Further, each mobile terminal 51 may include the GPS sensor 11, the manipulation section 17 and the display section 18 shown in FIG. 3; and the server 52 may include the time series data storing section 12, the behavior learning section 13, the behavior recognizing section 14, the behavior predicting section 15 and the arrival time predicting section 16 shown in FIG. 3.

With such a configuration, in the learning process, the mobile terminal 51 transmits the time series data acquired by the GPS sensor 11. The server 52 learns the activity state of the user by the probabilistic state transition model, on the basis of the received time series data for learning. Further, in the prediction process, the mobile terminal 51 transmits the destination designated by the user through the manipulation section 17, and transmits the GPS data acquired by the GPS sensor 11 in real time. The server 52 recognizes the current activity state of the user, that is, the current location of the user, using the parameters obtained through learning, and transmits the path and time up to the designated destination to the mobile terminal 51 as the process result. The mobile terminal 51 displays the process result transmitted from the server 52 through the display section 18.

Further, for example, the mobile terminal 51 may include the GPS sensor 11, the behavior recognizing section 14, the behavior predicting section 15, the arrival time predicting section 16, the manipulation section 17 and the display section 18 shown in FIG. 3; and the server 52 may include the time series data storing section 12 and the behavior learning section 13 shown in FIG. 3.

With such a configuration, the mobile terminal 51 transmits the time series data acquired by the GPS sensor 11 in the learning process. The server 52 learns the activity state of the user by the probabilistic state transition model on the basis of the received time series data for learning, and then transmits the parameters obtained through learning to the mobile terminal 51. Further, in the prediction process, the mobile terminal 51 recognizes the GPS data acquired in real time by the GPS sensor 11, that is to say, the current location of the user, using the parameters received from the server 52, and then calculates the path and time up to the designated destination. Further, the mobile terminal 51 displays the path and time up to the destination as the calculation result on the display section 18.

Division of roles between the mobile terminal 51 and the server 52 as described above can be determined according to a process capability of each data processing apparatus or a communication environment.

In the learning process, the time necessary for one process is very long, but it is not necessary to frequently perform the process. Accordingly, since the server 52 generally has a higher process capability than the portable mobile terminal 51, it is possible to allow the server 52 to perform the learning process (parameter updating) on the basis of the time series data stored one time a day.

On the other hand, it is preferable that the prediction process is rapidly performed in correspondence with the location data updated in real time every moment for display, and thus it is preferable that the process is performed in the mobile terminal 51. If the communication environment is rich, it is preferable that the prediction process is performed in the server 52 as described above and only the prediction result is received from the server 52, to thereby reduce the burden of the mobile terminal 51 which is preferably miniaturized to be portable.

Further, in a case where the mobile terminal 51 can independently perform the learning process and the prediction process as the data processing apparatus at a high speed, the mobile terminal 51 can be provided with the entire configuration of the prediction system 1 in FIG. 3.

### [Example of Input Time Series Data]

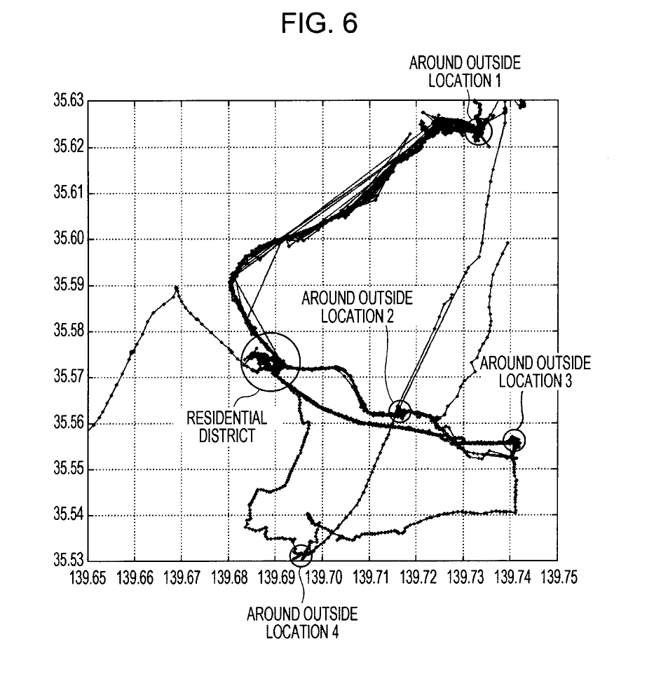

FIG. 6 is a diagram illustrating an example of the time series data on the locations acquired in the prediction system 1. In FIG. 6, the horizontal axis represents the longitude, and the vertical axis represents the latitude. In FIG. 6, for simplicity of the description, a time in each location is not shown, but in reality, the time in each location is included in the time series data.

The time series data shown in FIG. 6 is time series data stored in a period of about one and a half month by an experimenter. As shown in FIG. 6, the time series data includes data on a residential district and four outside movement locations such as a work location. The time series data also includes data in which the location data is missing due to being out of reach of the satellite.

### [Ergodic HMM]

Next, the ergodic HMM employed by the prediction system 1 as the learning model will be described.

FIG. 7 is a diagram illustrating an example of an HMM.

The HMM is a state transition model having states and inter-state transitions.

FIG. 7 is a diagram illustrating an example of a three-state HMM.

In FIG. 7 (the same with the subsequent figures), a circle represents a state, and an arrow represents a state transition. The state corresponds to the activity state of the user, and is referred to as state node.

Further, in FIG. 7, sᵢ (i=1, 2 and 3 in FIG. 7) represents a state (node), aᵢⱼ represents a state transition probability to a state sⱼ from the state sᵢ. Further, bⱼ(x) represents an output probability density function (observation probability) in which an observation value x is observed in the state transition to the state sⱼ, and πᵢ represents an initial probability in which the state sᵢ is an initial state.

As the output probability density function bⱼ(x) for example, a contaminated normal probability distribution or the like is used.

Here, the HMM (continuous HMM) is defined by the state transition probability aᵢⱼ, the output probability density function bⱼ(x) and the initial probability πᵢ. The state transition probability aᵢⱼ, the output probability density function bⱼ(x) and the initial probability πᵢ are referred to as HMM parameters λ={aᵢⱼ, bⱼ(x), πᵢ, where i=1, 2, . . . M, j=1, 2, . . . M}. M represents the number of HMM states.

As a method for estimating the HMM parameters λ, the Baum-Welch likelihood estimation method is widely used. The Baum-Welch likelihood estimation method is a parameter estimation method based on the EM algorithm (Expectation-Maximization algorithm).

According to the Baum-Welch likelihood estimation method, the HMM parameters λ are estimated so that a likelihood calculated from an occurrence probability which is a probability that the time series data is observed (occurs) is maximized, on the basis of the observed time series data x=x₁, x₂, . . . x_{T}. Here, xₜ represents a signal (sample value) observed at a time t, and T represents the length (sample number) of the time series data.

The estimation of the parameters λ using the Baum-Welch's likelihood estimation method will be described in detail with reference to FIG. 12.

The Baum-Welch likelihood estimation method is, for example, disclosed in “Pattern Recognition and Machine Learning”, C. M. Bishop, P333 (English original: “Pattern Recognition and Machine Learning (Information Science and Statistics)”, Christopher M. BishopSpringer, New York, 2006) (hereinafter, referred to as “document A”).

The Baum-Welch likelihood estimation method is a parameter estimating method based on likelihood maximization, but does not ensure optimalization, and may converge to a local solution according to a structure of the HMM or initial values of the parameters λ.

The HMM is generally used in sound recognition. In the HMM used in the sound recognition, the number of states, types of state transitions and the like are generally determined in advance.

FIG. 8 is a diagram illustrating an example of the HMM used in the sound recognition.

The HMM in FIG. 8 is referred to as left-to-right type.

In FIG. 8, the number of the states becomes 3, and the state transition is restricted to a structure in which a self transition (state transition to a state sᵢ from a state sᵢ) and a state transition to a right neighboring state from the left only are allowed.

Compared with the HMM with the restriction to the state transition as shown in FIG. 8, the HMM without the restriction to the state transition as shown in FIG. 7, that is, the HMM in which the state transition is possible from an arbitrary state sᵢ to an arbitrary state sⱼ is referred to as “ergodic HMM”.

The ergodic HMM is an HMM having the highest degree of freedom as a structure, but if the number of the states is increased, it is difficult to estimate the parameters λ.

For example, if the number of the states in the ergodic HMM is 1000, the number of the state transitions becomes 1,000,000 (=1000×1000).

Accordingly, in this case, for example, it is necessary to estimate 1,000,000 items of state transition probabilities aᵢⱼ, with respect to the state transition probability aᵢⱼ in the parameters λ.

Thus, it is possible to apply a restriction (sparse restriction) called a sparse structure to the state transition set for the state, for example.

Here, the sparse structure is a structure in which states capable of being state-transited from a certain state are limited, which is not a tight state transition such as an ergodic HMM in which the state transition is possible from an arbitrary state to another arbitrary state. In this respect, it is assumed that at least one state transition to other states exists even in the sparse structure, and a self transition exists.

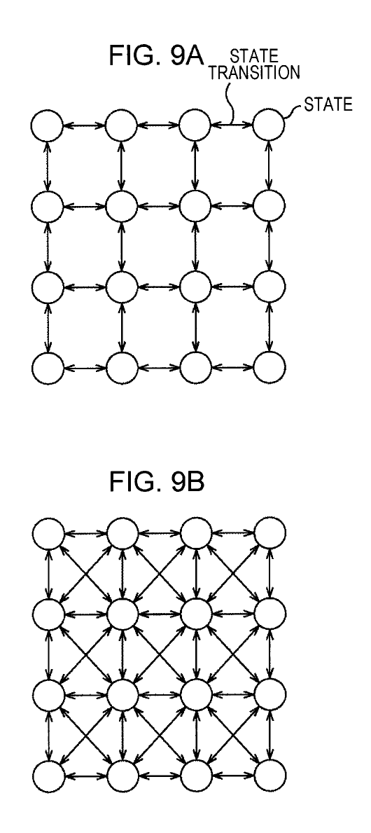

FIG. 9 illustrates the HMM to which a sparse restriction is applied.

In FIG. 9, a bi-directional arrow which connects two states represents a state transition from one direction of the two states to the other direction thereof, and a state transition from the other direction thereof to the one direction thereof. Further, in FIG. 9, a self transition can be performed in each state, and an arrow indicating the self transition is not shown in the figure.

In FIG. 9, 16 states are arranged in a two-dimensional space in a lattice shape. That is, in FIG. 9, 4 states are arranged in the transverse direction and 4 states are also arranged in the longitudinal direction.

If it is assumed that the distance between the states adjacent to each other in the transverse direction, and the distance between the states adjacent to each other in the longitudinal direction are all 1, FIG. 9A illustrates the HMM to which a sparse restriction is applied, in which a state transition to a state in which the distance is equal to 1 or smaller is allowed, and a state transition to other states is not allowed.

Further, FIG. 9B illustrates the HMM to which a sparse restriction is applied, in which a state transition to a state in which the distance is equal to √2 or smaller is allowed, and a state transition to other states is not allowed.

In this embodiment, the GPS data acquired by the GPS sensor 11 is supplied to the time series data storing section 12 as time series data. The behavior learning section 13 estimates the HMM parameters λ indicating the user activity model, using the time series data x=x₁, x₂, . . . x_{T} on locations, among the time series data of the GPS data which is stored in the time series data storing section 12.

That is, the location (latitude and longitude) data on each time indicating a movement trace of the user is considered an observation data on probability variables which are normally distributed using spreading of a predetermined dispersion value from one point on a map corresponding to any one of the HMM states sⱼ. The behavior learning section 13 optimizes the one point on the map corresponding to each state sⱼ, the dispersion value thereof, and the state transition probability aᵢⱼ.

The behavior recognizing section 14 applies a Viterbi rule to the user activity model (HMM) obtained through learning, and calculates a course (state series) (path) (hereinafter, referred to as likelihood path) of a state transition in which a likelihood in which the location data x=x₁, x₂, . . . x_{T} is observed from the GPS sensor 11 becomes the maximum. Thus, a current activity state of the user, that is, the state sᵢ corresponding to the current location of the user is recognized.

Here, the Viterbi rule is an algorithm for determining a path (likelihood path), among the paths of the state transitions using each state sᵢ as a starting point, in which a value (occurrence probability) obtained by accumulating, the state transition probability aᵢⱼ in which the state sᵢ is transited to the state sⱼ at the time t and a probability (output probability obtained from the output probability density function bⱼ(x)) in which a sample value xₜ at the time t in the location data x=x₁, x₂, . . . x_{T} in the state transition is observed, over the length T of the time series data x after processing, becomes the maximum. Details of the Viterbi rule are disclosed in the above-described document A, P.347.

### [Search Process of Path Through Behavior Predicting Section 15]

Next, a search process of the path by means of the behavior predicting section 15 will be described.

Each state sᵢ of the HMM obtained through learning represents a predetermined point (location) on the map, and may represent a path from the state sᵢ to the state sⱼ when the state sᵢ and the state sⱼ are connected to each other.

In this case, each point corresponding to the state sᵢ can be classified into any one of an end point, a pass point, a branch point and a loop. The end point is a point in which a probability other than the self transition is very small (probability other than the self transition is equal to a predetermined value or lower), in which a further movable point does not exist. The pass point is a point in which there exists one significant transition other than the self transition, in other words, there exists one further movable point. The branch point is a point in which there exist two or more significant transitions other than the self transition, that is, there exist two or more further movable points. The loop is a point which coincides with any one of the paths which has been passed up to now.

In a case where the path for the destination is searched, if there are different paths, it is preferable to present information on a necessary time or the like for the respective paths. Thus, in order to search available paths proportionately, the next conditions are set.

(1) Even though a path is branched once and joined again, it is considered as a different path.

(2) In a case where the end point in the path or a point included in the path which is passed up to now appears, the search of the path is terminated.

The behavior predicting section 15 uses a current activity state of the user which is recognized by the behavior recognizing section 14, that is, the current point of the user as a departure location, and classifies a state transition available point which is the next movement location as one of the end point, pass point, branch point, and loop, which will be repeated up to the termination condition (2).

In a case where the current point is classified as the end point, the behavior predicting section 15 connects the current point to the path up to now and then terminates the search of the path.

On the other hand, in a case where the current point is classified as the pass point, the behavior predicting section 15 connects the current point to the path up to now and then moves it to the next point.

Further, in a case where the current point is classified as the branch point, the behavior predicting section 15 connects the current point to the path up to now, copies the path up to now by the number of the branches, and then connects it to the branch point. Further, the behavior predicting section 15 moves one of the branch points to become the next point.

In a case where the current point is classified as the loop, the behavior predicting section 15 terminates the search of the path without connecting the current point to the path up to now. Since a case of turning back the path from the current point to a point directly before is included in the loop, this is not considered.

### [Example of Search Process]

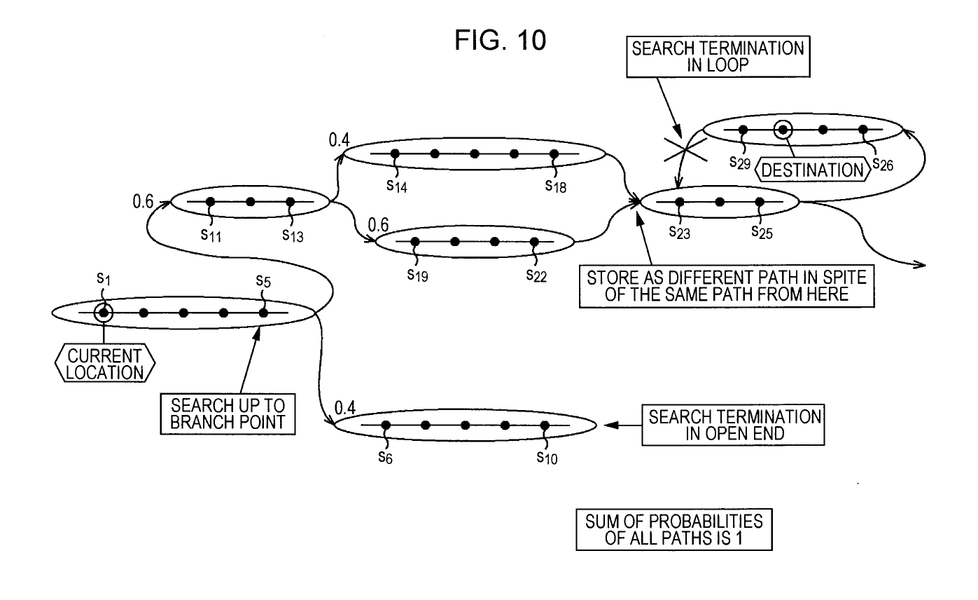

FIG. 10 is a diagram illustrating a simple example of a search process of the path by means of the behavior predicting section 15.

In the example shown in FIG. 10, in a case where a state s₁ is the current location, three paths are finally searched. The first path is a path leading to a state s₁₀ from the state s₁ through a state s₅, a state s₆ and the like (hereinafter, referred to as path A). The second path is a path leading to a state s₂₉ from the state s₁ through a state s₅, a state s₁₁, a state s₁₄, a state s₂₃ and the like (hereinafter, referred to as path B). The third path is a path leading to the state s₂₉ from the state s₁ through the state s₅, the state s₁₁, a state s₁₉, the state s₂₃ and the like (hereinafter, referred to as path C).

The behavior predicting section 15 calculates a probability (path selection probability) that each searched path is selected. The path selection probability is obtained by sequentially multiplying the transition probability between states for forming the path. Here, since it is necessary to consider only the case being transited to the next state but not necessary to consider the case of staying in the location, the path selection probability is calculated using a transition probability [aᵢⱼ] regulated by removing the self transition probability from the state transition probability aᵢⱼ of each state obtained through learning.

The transition probability [aᵢⱼ] regulated by removing the self transition probability can be expressed as the following equation (1).

$$[ {a}_{ij} ] = \frac{( 1 - {δ}_{ij} ) {a}_{ij}}{{\sum }_{j = 1}^{N} ( 1 - {δ}_{ij} ) {a}_{ij}} \qquad ( 1 )$$

Here, δ represents a Kronecker function, which becomes 1 only when suffixes i and j coincide with each other, and becomes 0 in all other cases.

Accordingly, for example, in the state transition probability aᵢⱼ of the state s₅ in FIG. 10, in a case where a self transition probability a_{5.5} is 0.5, a transition probability a_{5.6} is 0.2, and a transition probability a_{5.11} is 0.3, a transition probability [a_{5.6}] and a transition probability [a_{5.11}] in a case where the state a₅ is branched to the state s₆ or the state s₁₁ are 0.4 and 0.6, respectively.

When a node number i of the state sᵢ of the searched path is (y₁, y₂, . . . yₙ), a selection probability of the path can be expressed as the following equation (2), using the regulated transition probability [aᵢⱼ].

$$\begin{matrix}P ( {y}_{1} , {y}_{2} , … , {y}_{n} ) = [ {a}_{{y}_{1} {y}_{2}} ] [ {a}_{{y}_{2} {y}_{3}} ] … [ {a}_{{y}_{n - 1} {y}_{n}} ] \\ = {\prod }_{i = 1}^{n - 1} [ {a}_{{y}_{i - 1} {y}_{i}} ]\end{matrix} \qquad ( 2 )$$

Actually, since the regulated transition probability [aᵢⱼ] in the pass point is 1, the regulated transition probability [aᵢⱼ] at the time of branching may be sequentially multiplied.

In the example shown in FIG. 10, a selection probability of the path A is 0.4. Further, a selection probability of the path B is 0.24=0.6×0.4. A selection probability of the path C is 0.36=0.6×0.6. Further, it can be found that the total sum of the calculated selection probabilities of the paths is 1=0.4+0.24+0.36 and the search can be proportionately performed.

As described above, each path searched on the basis of the current location and the selection probability thereof are supplied from the behavior predicting section 15 to the arrival time predicting section 16.

The arrival time predicting section 16 extracts a path including a destination which is designated by a user from the path which is searched by the behavior predicting section 15, and also predicts the time up to the destination for each extracted path.

For example, in the example shown in FIG. 10, paths including the state s₂₈ which is the destination, among the three searched paths A to C, are the paths B and C. The arrival time predicting section 16 predicts the time taken to reach the state S₂₈ which is the destination, through the path B or C.

In a case where there are many paths including the destination and thus it is difficult to see all paths displayed, or in a case where a presented number of the paths is set to a predetermined number, it is necessary to determine a path (hereinafter, approximately referred to as display path) to be displayed on the display section 18, from all the paths including the destination. In such a case, since the selection probability for each path is calculated in the behavior predicting section 15, the arrival time predicting section 16 can determine the paths of the predetermined number as the display paths in descending order of the selection probability.

It is assumed that the current location of the current time t₁ is a state s_{y1}, paths determined at a time (t₁, t₂, . . . t_{g}) is (s_{y1}, s_{y2}, . . . s_{yg}). In other words, it is assumed that the node number i of the determined path state sᵢ is (y₁, y₂, . . . y_{g}). Hereinafter, for simplicity of the description, the state sᵢ corresponding to the location may be simply indicated as the node number i.

Since the current location y₁ at the current time t₁ is specified by recognition of the behavior recognizing section 14, a probability P_{y1}(t₁) that the current location at the current time t₁ is y₁ is 1. Further, a probability that the current location is in a state other than y₁ at the current time t₁ is 0.

On the other hand, a probability P_{yn}(tₙ) that the current location is in the node number yₙ at a predetermined time tₙ can be expressed as the following equation (3).

P_{y}_{ₙ}(tₙ)=P_{y}_{ₙ}(tₙ−1)a_{y}_{ₙ}_{y}_{ₙ}+P_{y}_{ₙ₋₁}(tₙ−1)a_{y}_{ₙ₋₁}_{y}_{ₙ} (3)

Here, a first term on the right side of the equation (3) represents a probability that the current location is disposed in the original location yₙ and the self transition is performed; and a second item on the right side a probability that the transition is performed to the location yₙ from a location yₙ₋₁ which is disposed directly before. In the equation (3), differently from the calculation of the path selection probability, the state transition probability aᵢⱼ obtained through learning is used as it is.

A prediction value <t_{g}> of the time t_{g} at the time of reaching the destination y_{g} can be expressed as the following equation (4), using a “probability that the current location is disposed in a location y_{g-1}, directly before the destination y_{g} at a time t_{g-1} directly before the time t_{g} and moves to the destination y_{g} at the time t_{g}”.

$$〈 {t}_{g} 〉 = {Σ}_{t} {t}_{g} ( \frac{{P}_{{x}_{g - 1}} ( {t}_{g - 1} - 1 ) {a}_{{x}_{g - 1} {x}_{g}}}{{Σ}_{t} {P}_{{x}_{g - 1}} ( {t}_{g} - 1 ) {a}_{{x}_{g - 1} {x}_{g}}} ) \qquad ( 4 )$$

That is, the prediction value <t_{g}> is expressed as an expectation value of the time until “the current location is disposed in a state s_{yg-1} directly before a state s_{yg} at the time t_{g-1} directly before the time t_{g} and moves to the state s_{yg} at the time t_{g}” from the current time.

In a case where the prediction value of the arrival time for the destination is calculated through the method in Japanese Patent Application No. 2009-180780 presented in “BACKGROUND OF THE INVENTION”, it is necessary to integrate the state transition probability aᵢⱼ of the state corresponding to the destination “after a predetermined time” with respect to the time t. In this case, it is important to set the amount of the integral section. In Japanese Patent Application No. 2009-180780, it is difficult to discern a case of reaching the destination through a loop path. Thus, in a case where the loop exists in the middle of the path to the destination, if the integral section is set to be long, since cases of reaching the destination for the second or third time through the loop are included therein, it is difficult to accurately calculate the arrival time up to the destination.

In the calculation of the prediction value of the arrival time for the destination according to the embodiment of the present invention, expressed as the equation (4), it is similarly necessary to perform the integration (Σ) for the time t. However, in the search path, since the case of reaching the destination through the loop path is excluded, it is possible to set a sufficiently long section as the integral section of an expectation value. The integral section in the equation (4) may be set to about one or two times of the maximum movement time in the learned path, for example.

### [User Activity Model Learning Process]

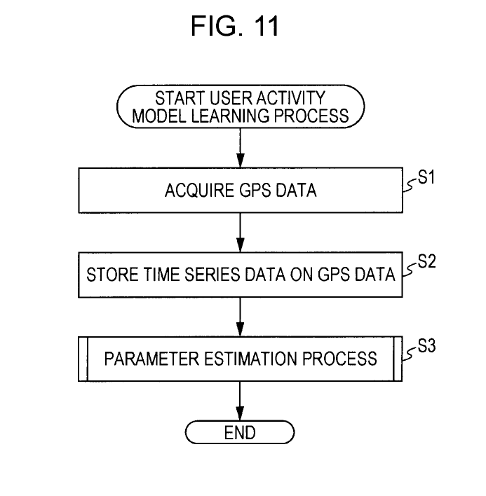

Next, a user activity model learning process of learning a movement path of the user as a probabilistic state transition model indicating an activity state of the user, will be described with a reference to a flowchart in FIG. 11.

Firstly, in step S1, the GPS sensor 11 acquires GPS data and then supplies it to the time series data storing section 12. That is, the GPS sensor 11 measures the latitude and longitude of a current location, and supplies the GPS data indicating the measured location (latitude and longitude) and the measured time thereof.

In step S2, the time series data storing section 12 stores the GPS data which is continuously acquired by the GPS sensor 11, that is, the time series data on the locations and the measured times.

In step S3, the behavior learning section 13 performs a parameter estimation process, and terminates the user activity model learning process.

### [Parameter Estimation Process]

Here, the parameter estimation process in step S3 in FIG. 11 will be described in detail with reference to FIG. 12.

In step S21, the data interpolating section 31 acquires the time series data of the GPS data, that is, the time series data on the locations and measured times stored in the time series data storing section 12.

In step S22, the data interpolating section 31 performs a data interpolation process.

### [Data Interpolation Process]

Here, the data interpolation process in step S22 in FIG. 12 will be described in detail with reference to a flowchart in FIG. 13.

In step S51, the data interpolating section 31 searches a missing period in the time series data. As described above, while the GPS sensor 11 is able to capture the signals from the satellite, the GPS data is acquired at predetermined time intervals (hereinafter, referred to as sampling period). Accordingly, the data interpolating section 31 searches a period during which the interval at which the GPS data is acquired is longer than the sampling period, on the basis of the measured time of each piece of data of the time series data, and sets the detected period as the missing period.

In step S52, the data interpolating section 31 interpolates time data. That is, the data interpolating section 31 interpolates a measured time of the time series data in the missing period, on the basis of the sampling period of the GPS data.

In step S53, the data interpolating section 31 interpolates location data corresponding to the interpolated measured time.

For example, as a method of interpolating the location data, there is considered a method of fixing a location of the GPS data in the missing period to a location (hereinafter, referred to as banishing point) measured directly before the missing period. This method is easy, but since the location in the missing period is fixed regardless of the location (hereinafter, referred to as a restoring point) measured directly after the missing period, the reliability of the interpolated location data is lowered.

Thus, the data interpolating section 31 interpolates the location data by performing a linear interpolation between the banishing point and the restoring point. That is, the data interpolating section 31 arranges points of the same number as the number of samples in the missing period at an equivalent interval, on a straight line connecting the banishing point to the restoring point, and interpolates data indicating the locations of the arranged points as the location data corresponding to each measured time interpolated.

Instead of the straight line interpolation method, for example, the location data may be interpolated, using a primary or more multi-nominal expression interpolation, a logarithmic interpolation, an interpolation using a sync function, or the like.

In step S54, the data interpolating section 31 sets the reliability of the location data. Specifically, the interpolated location data (hereinafter, referred to as interpolation location data) has a low data reliability, compared with location data (hereinafter, referred to as normal location data) which originally exists in a period (hereinafter, referred to as normal period) other than the missing period. Thus, for example, the data interpolating section 31 adds parameters for discerning two pieces of data to the time series data so that the normal location data and the interpolation location data can be distinguished from each other later. Accordingly, it is possible to distinguish the normal location data from the interpolation location data in the subsequent process, and to handle the interpolation location data as data having a low reliability.

Further, for example, the data interpolating section 31 sets dispersion (or standard deviation) around a value of each location data, as the reliability indicating how close the value of each location data is to a location (hereinafter, referred to as actual location) which actually exists at that time. For example, the data interpolating section 31 sets the dispersion of the normal location data to 0 or a predetermined constant number, and sets the dispersion of the interpolation location data to a constant number larger than the dispersion of the normal location data.

Alternately, the dispersion of the interpolation location data may be set to a value according to the location, not to the constant number. Specifically, it is considered that the location shown in the interpolation location data has a small difference to the actual location when data is close to the beginning or end of the missing period, and has a large difference to the actual location when data is distant from the beginning or end of the missing period. Thus, for example, the data interpolating section 31 sets the dispersion to a small value (that is, sets the reliability at a high level) when the interpolation location data is temporally close to the beginning or end of the missing period, and sets the dispersion to a large value (that is, sets the reliability at a low level) as the interpolation location data is temporally distant from the beginning or end of the missing period.

The dispersion (or standard deviation) set at this reliability shows that the location shown in the interpolation location data is not necessarily a correct value, but the correct location is probabilistically found in the set dispersion (or standard deviation) around the location.

In step S55, the data interpolation section 31 supplies the interpolated time series data to the state likelihood calculating section 32. That is, the data interpolating section 31 interpolates the measured time and location data in the missing period, and supplies the time series data in which the reliability of each piece of location data is set to the state likelihood calculating section 32. Thereafter, the data interpolation process is terminated.

### [Subsequent Parameter Estimation Process]

Returning to FIG. 12, in step S23, the state likelihood calculating section 32 calculates the likelihood of each state for the location data. Specifically, the state likelihood calculating section 32 calculates a state likelihood P(sᵢ|xₜ) in a case where it is assumed that location data xₜ at a time t of the time series data is output, at the time of transition to a state sᵢ of the HMM indicating the user activity model, according to the following equation (5).

$$P ( {s}_{i} \vert {x}_{t} ) = \frac{1}{\sqrt{2 {{πσ}_{si} ( 1 )}^{2}}} exp ( - \frac{{( {x}_{t} ( 1 ) - {μ}_{si} ( 1 ) )}^{2}}{2 {{σ}_{si} ( 1 )}^{2}} ) \times \frac{1}{\sqrt{2 {{πσ}_{si} ( 2 )}^{2}}} exp ( - \frac{{( {x}_{t} ( 2 ) - {μ}_{si} ( 2 ) )}^{2}}{2 {{σ}_{si} ( 2 )}^{2}} ) … \times \frac{1}{\sqrt{2 {{πσ}_{si} ( D )}^{2}}} exp ( - \frac{{( {x}_{t} ( D ) - {μ}_{si} ( D ) )}^{2}}{2 {{σ}_{si} ( D )}^{2}} ) \qquad ( 5 )$$

Here, time t represents a turn of time series data, not a measured time of the time series data, which is a value from 1 to T (the number of samples of the time series data).

Further, in equation (5), D represents the number of dimensions of the location data. In this case, since the location data contains the two dimensions of the latitude and longitude, D=2. Further, it is assumed that xₜ(1) and xₜ(2) represent the latitude and the longitude of the location data xₜ, respectively. Further, output probability density functions of the latitude and the longitude of the location data output at the time of transition to the state sᵢ have a single normal distribution, respectively. Further, μₛᵢ(1) and σₛᵢ(1) represent a center value and a standard deviation of the output probability density function of the latitude, respectively, and μₛᵢ(2) and σₛᵢ(2) represent a center value and a standard deviation of the output probability density function of the longitude, respectively.

The equation (5) is an equation which is generally used in a Baum-Welch maximum likelihood estimation method.

The state likelihood calculating section 32 calculates the state likelihood P(sᵢ|xₜ) according to the equation (5), with respect to combinations of all states sᵢ and the location data xₜ, and supplies data indicating the calculated state likelihood P(sᵢ|xₜ) and the time series data to the state likelihood modifying section 33.

In step S24, the state likelihood modifying section 33 modifies the likelihood of each state for the interpolated location data. For example, the state likelihood modifying section 33 modifies the state likelihood P(sᵢ|xₜ) for the interpolated location data xₜ, according to the following equation (6).

P(sᵢ|xₜ)=1/m (6)

In the equation (6), M represents the number of state nodes of the HMM.

The equation (6) represents a state likelihood P(sᵢ|xₜ) in a case where it is assumed that probabilities of transitions to the respective states sᵢ when the location data xₜ at the time t in the missing period is output are all the same, and the state likelihoods P(sᵢ|xₜ) for the interpolation location data become all the same value.

Alternately, for example, the state likelihood modifying section 33 modifies the state likelihood P(sᵢ|xₜ) for the interpolated location data xₜ according to the equation (7).

$$P ( {s}_{i} \vert {x}_{t} ) = exp ( - {\sum }_{d}^{D} \frac{{( {x}_{t} ( d ) - {μ}_{si} ( d ) )}^{2}}{( {{σ}_{si} ( d )}^{2} + {{σ}_{t} ( d )}^{2} )} ) \qquad ( 7 )$$

As the σₜ(d)² in the equation (7), the dispersion set as the reliability of each location data in the process of step S54 in FIG. 13 is used.

Thus, the reliability of the interpolation location data is reflected in the state likelihood P(sᵢ|xₜ), the state likelihood P(sᵢ|xₜ) for the interpolation location data is set to a relatively lower value than the state likelihood P(sᵢ|xₜ) for the normal location data. That is, with respect to the interpolation location data and the normal location data of the same value, the state likelihood P(sᵢ|xₜ) for the interpolation location data is set to a value lower than the state likelihood P(sᵢ|xₜ) for the normal location data. Further, the state likelihood P(sᵢ|xₜ) for the interpolation location data becomes higher as the reliability of the interpolation location data becomes higher (as the dispersion σₜ(d)² becomes smaller), and becomes lower as the reliability of the interpolation location data becomes lower (as the dispersion σₜ(d)² becomes larger).

The state likelihood modifying section 33 modifies the state likelihood P(sᵢ|xₜ) according to the equation (6) or (7), with respect to combinations of all the states sᵢ and all the interpolated location data xₜ. The state likelihood modifying section 33 supplies all data on the likelihoods P(sᵢ|xₜ) including the state modified likelihood P(sᵢ|xₜ) and the time series data to the forward likelihood calculating section 34.

Through the process of step S24, consequently, the state likelihood P(sᵢ|xₜ) for the interpolation location data and the state likelihood P(sᵢ|xₜ) for the normal location data are calculated in different conditions. In step S23, the state likelihood P(sᵢ|xₜ) for the interpolation location data may not be calculated.

In step S25, the forward likelihood calculating section 34 calculates a forward likelihood. That is, the forward likelihood calculating section 34 calculates a forward likelihood σₜ(sᵢ) of the state sᵢ at the time t, in order from the time 1 to the final time T, according to the following equations (8) and (9).

$$\begin{matrix}{α}_{1} ( {s}_{i} ) = {π}_{si} & ( 8 ) \\ {α}_{t} ( {s}_{i} ) = {\sum }_{j = 1}^{M} {α}_{t - 1} ( {s}_{j} ) {a}_{ji} P ( {s}_{i} \vert {x}_{t} ) & ( 9 )\end{matrix}$$

In the equation (8), πₛᵢ represents an initial probability of the state sᵢ. Further, in the equation (9), aⱼᵢ represents a state transition probability from the state sⱼ to the state sᵢ. The initial probability πₛ, and an initial value of the state transition probability aⱼᵢ are given from the outside, for example.

The equations (8) and (9) are equations which are generally used in a forward algorithm of the Baum-Welch maximum likelihood estimation method.

The forward likelihood calculating section 34 calculates forward likelihoods αₜ(sᵢ) of all the states sᵢ at each time t. Further, the forward likelihood calculating section 34 adds data indicating the calculated forward likelihoods αₜ(sᵢ) to the data acquired from the state likelihood modifying section 33, and then supplies it to the backward likelihood calculating section 35.

In step S26, the backward likelihood calculating section 35 calculates a backward likelihood. That is, the backward likelihood calculating section 35 calculates a backward likelihood βₜ(sᵢ) of the state sᵢ at the time t, using the following equations (10) and (11), in reverse order from the final time T to the time 1.

$$\begin{matrix}{β}_{T} ( {s}_{i} ) = 1 / m & ( 10 ) \\ {β}_{t} ( {s}_{i} ) = {\sum }_{j = 1}^{M} {a}_{ij} P ( {s}_{i} \vert {x}_{t + 1} ) {β}_{t + 1} ( {s}_{j} ) & ( 11 )\end{matrix}$$

In the equation (10), it is assumed that the probabilities of the respective states sᵢ at the time T are all the same.

The equations (10) and (11) are those which are generally used in a backward algorithm of the Baum-Welch maximum likelihood estimation method.

The backward likelihood calculating section 35 calculates the backward likelihoods βₜ(sᵢ) of the all the states sᵢ at each time t. Further, the backward likelihood calculating section 35 adds data indicating the calculated backward likelihood βₜ(sᵢ) to the data acquired from the forward likelihood calculating section 34, and then supplies it to the initial probability and transition probability estimating section 36.

In this way, through the processes of steps S23 to S26, a variety of likelihoods of the Hidden Markov Model is calculated for the time series data in which the data is interpolated.

In step S27, the initial probability and transition probability estimating section 36 updates the initial probability and the state transition probability. That is, the initial probability and transition probability estimating section 36 updates the initial probability πₛᵢ of each state sᵢ and the state transition probability aᵢⱼ between the states into an initial probability πₛᵢ′ and a state transition probability aᵢⱼ′ which are calculated by the equations (12) and (13), respectively.

$$\begin{matrix}{π}_{si}^{′} = \frac{{α}_{1} ( {s}_{i} ) {β}_{1} ( {s}_{i} )}{{\sum }_{i = 1}^{M} {α}_{t} ( {s}_{i} )} & ( 12 ) \\ {a}_{ij}^{′} = \frac{{\sum }_{t = 1}^{T - 1} {α}_{t} ( {s}_{i} ) {a}_{ij} P ( {s}_{j} \vert {x}_{t + 1} ) {β}_{t + 1} ( {s}_{j} )}{{\sum }_{t = 1}^{T - 1} {α}_{t} ( {s}_{i} ) {β}_{t} ( {s}_{i} )} & ( 13 )\end{matrix}$$

The equations (12) and (13) are those which are generally used in the Baum-Welch maximum likelihood estimation method.

The initial probability and transition probability estimating section 36 adds data indicating the updated initial probability πᵢⱼ and state transition probability aᵢⱼ to the data acquired from the backward likelihood calculating section 35, and then supplies it to the observation probability estimating pre-processing section 37.

In step S28, the observation probability estimating pre-processing section 37 reduces the contribution level to the observation probability of the interpolated location data. Specifically, the observation probability estimating pre-processing section 37 sets the forward likelihood αₜ(sᵢ) and the backward likelihood βₜ(sᵢ) at the time t in the missing period to all 0. The observation probability estimating pre-processing section 37 supplies data obtained by modifying the forward likelihood αₜ(sᵢ) and the backward likelihood βₜ(sᵢ) as described above, with respect to the data obtained from the initial probability and transition probability estimating section 36, to the observation probability estimating section 38.

In step S29, the observation probability estimating section 38 updates the observation probability. That is, the observation probability estimating section 38 updates the center value μₛᵢ(d) of the output probability density function of each state sᵢ, and the dispersion σₛᵢ(d)² into a center value μₛᵢ(d)′ and dispersion σₛᵢ(d)′² which are calculated by the following equations (14) and (15), respectively.

$$\begin{matrix}{{μ}_{si} ( d )}^{′} = \frac{{\sum }_{t = 1}^{T} {α}_{t} ( {s}_{i} ) {β}_{t} ( {s}_{i} ) {x}_{t} ( d )}{{\sum }_{t = 1}^{T} {α}_{t} ( {s}_{i} ) {β}_{t} ( {s}_{i} )} & ( 14 ) \\ {{{σ}_{si} ( d )}^{′}}^{2} = \frac{{\sum }_{t = 1}^{T} {α}_{t} ( {s}_{i} ) {β}_{t} ( {s}_{i} ) {( {x}_{t} ( d ) - {μ}_{si} ( d ) )}^{2}}{{\sum }_{t = 1}^{T} {α}_{t} ( {s}_{i} ) {β}_{t} ( {s}_{i} )} & ( 15 )\end{matrix}$$

In the equations (14) and (15), d represents the number of dimensions of the data, and in this case, d is 1 or 2.

The equations (14) and (15) are those which are generally used in the Baum-Welch maximum likelihood estimation method.

Here, in step S28, the forward likelihood αₜ(sᵢ) and the backward likelihood βₜ(sᵢ) at the time t in the missing period are set to all 0. Accordingly, without using a special calculation, the contribution level of the interpolation location data to the observation probability (center value μₛᵢ(d) and dispersion σₛᵢ(d)²) of each state sᵢ, which is almost zero, becomes lower than the contribution level of the normal location data. Thus, in the estimation of the observation probability, the interpolation location data having a low reliability is barely reflected, and thus, the estimation accuracy of the observation probability is enhanced.

In step S30, the observation probability estimating section 38 determines whether updating of parameters is to be terminated. In a case where a predetermined updating termination condition to be described later is not yet established, the observation probability estimating section 38 determines that the updating of the parameters is not to be terminated, and the procedure goes to step S31.

In step S31, the observation probability estimating section 38 supplies the updated parameters to the state likelihood calculating section 32. That is, the observation probability estimating section 38 supplies data indicating the initial probability πₛᵢ, the center value μₛᵢ(d) and dispersion σₛᵢ(d)² of the respective states sᵢ, and the state transition probability aᵢⱼ between the states, which are updated in the processes of steps S27 to S29, to the state likelihood calculating section 32.

Thereafter, in step S30, until it is determined that the updating of the parameters is to be terminated, the processes of step S23 to S31 are repeatedly performed. Thus, the variety of likelihoods of the series of states sᵢ, that is, the state likelihood P(sᵢ|xₜ), the forward likelihood αₜ and the backward likelihood βₜ(sᵢ) are sequentially increased, the updating of the parameters of the HMM is performed so that they finally reach the maximum.

On the other hand, in step S30, for example, in a case where an increment of each likelihood is equal to or lower than a predetermined value and a converging condition of the updating of the parameters is satisfied, the observation probability estimating section 38 determines that the updating of the parameters is to be terminated, and the procedure goes to step S32. Alternately, for example, in a case where the updating processes of step S23 to S31 are performed by predetermined times, the observation probability estimating section 38 determines that the updating of the parameters is to be terminated, and the procedure goes to step S32.

In step S32, the observation probability estimating section 38 supplies the final parameters to the state likelihood calculating section 32. That is, the observation probability estimating section 38 supplies data indicating the initial probability πₛᵢ, the center value μₛᵢ(d) and dispersion σₛᵢ(d)² of the respective states sᵢ, and the state transition probability aᵢⱼ between the states, which are finally calculated in the updating processes of steps S23 to S31, to the behavior recognizing section 14 and the behavior predicting section 15.

Then, the parameter estimation process is terminated.

### [Arrival Time Prediction Process]

Next, an arrival time prediction process of searching the path up to the destination using the parameters of the probabilistic state transition model indicating the user activity model obtained by the user activity model learning process in FIG. 11, calculating the arrival time and presenting it to the user, will be described.

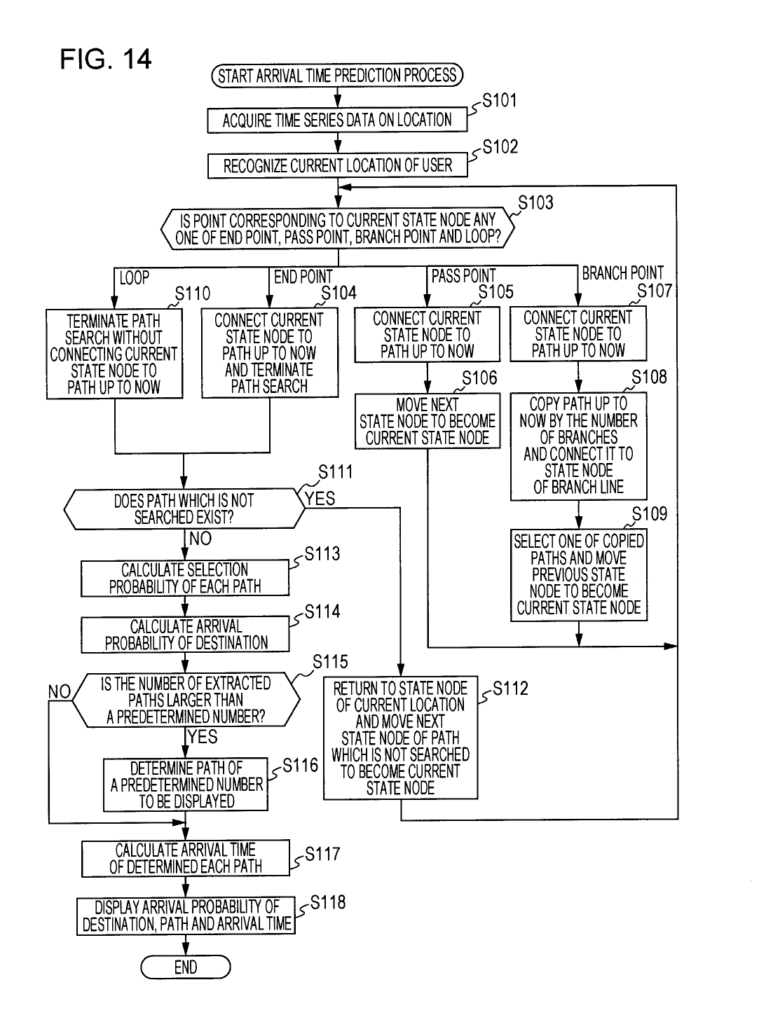

FIG. 14 is a flowchart illustrating the arrival time prediction process. In this example, the destination is determined in advance, before the process in FIG. 14. However, the destination may be input in the middle of the process in FIG. 14.

Firstly, in step S101, the GPS sensor 11 acquires the time series data on the locations and then supplies it to the behavior recognizing section 14. The time series data on the locations having a predetermined number of samples is temporarily stored in the behavior recognizing section 14.

In step S102, the behavior recognizing section 14 recognizes the current activity state of the user from the user activity model based on the parameters through learning. That is, the behavior recognizing section 14 recognizes the current location of the user. Further, the behavior recognizing section 14 supplies the node number of the current state node of the user to the behavior predicting section 15.

In step S103, the behavior predicting section 15 determines whether a point corresponding to the state node which is being currently searched (hereinafter, referred to as current state node) is any one of an end point, a pass point, a branch point and a loop. Right after the process in step S102, the state node corresponding to the current location of the user becomes the current state node.

In step S103, if it is determined that the point corresponding to the current state node is the end point, the procedure goes to step S104. Then, the behavior predicting section 15 connects the current state node to a path up to now and terminates the search of the path, and then procedure goes to step S111. If the current state node is a state node corresponding to the current location, since there is no path up to now, the connection process is not performed. This is the case with steps S105, S107 and S110.

In step S103, if it is determined that the point corresponding to the current state node is the pass point, the procedure goes to step S105. Then, the behavior predicting section 15 connects the current state node to the path up to now. Then, in step S106, the behavior prediction section 15 moves the next state node to become the current state node. After the process of step S106, the procedure returns to step S103.

In step S103, if it is determined that the point corresponding to the current state node is the branch point, the procedure goes to step S107. Then, the behavior predicting section 15 connects the current state node to the path up to now. Then, in step S108, the behavior prediction section 15 copies the path up to now by the number of branches, and then connects them to the state nodes of the branch lines. Further, in step S109, the behavior predicting section 15 selects one of the copied paths, and moves the state node before the selected path to become the current state node. After the process of step S109, the procedure returns to step S103.

On the other hand, in step S103, if it is determined that the point corresponding to the current state node is the loop, the procedure goes to step S110. Then, the behavior predicting section 15 terminates the search of the path without connecting the current state node to the path up to now, and then the procedure goes to step S111.

In step S111, the behavior predicting section 15 determines whether there exists a path which is not searched. In step S111, if it is determined that an unsearched path exists, the procedure goes to step S112. Then, the behavior predicting section 15 allows the procedure to return to the state node of the current location, and moves the next state node of the unsearched path to become the current state node. After the process of step S112, the procedure returns to step S103. Thus, the search of the path is performed until the search is terminated by the end point or the loop with respect to the unsearched path.

In step S111, if it is determined that the unsearched path does not exist, the procedure goes to step S113. Then, the behavior predicting section 15 calculates the selection probability (occurrence probability) of each searched path. The behavior predicting section 15 supplies each path and its selection probability to the arrival time predicting section 16.

In step S114, the arrival time predicting section 16 extracts a path including the input destination from the path searched by the behavior predicting section 15, and then calculates the arrival probability for the destination. Specifically, in a case where a plurality of paths is present for the destination, the arrival time predicting section 16 calculates the sum of the selection probabilities of the plurality of paths as the arrival probability for the destination. In a case where only one path for the destination is present, the selection probability of the path becomes the arrival probability for the destination as it is.

In step S115, the arrival time predicting section 16 determines whether the number of the extracted paths is larger than a predetermined number which is set in advance as the presented number.

In step S115, if it is determined that the number of the extracted paths is larger than the predetermined number, the procedure goes to step S116. Then, the arrival time predicting section 16 determines the paths of the predetermined number displayed on the display section 18. For example, the arrival time predicting section 16 can determine the paths of the predetermined number, in descending order of the selection possibility.

On the other hand, in step S115, if it is determined that the number of the extracted paths is equal to or smaller than the predetermined number, the process of step S116 is skipped. That is, in this case, all paths for reaching the destination are displayed on the display section 18.

In step S117, the arrival time predicting section 16 calculates the arrival time of each path determined to be displayed on the display section 18. Further, the arrival time predicting section 16 supplies an image signal indicating the arrival probability for the destination and the path and the arrival time up to the destination to the display section 18.

In step S118, the display section 18 displays the arrival probability for the destination and the path and arrival time up to the destination, on the basis of the image signal supplied from the arrival time predicting section 16, and then the procedure is terminated.

### [Effects of the Present Invention]

As described above, the prediction system 1 performs the learning process in which the data in the missing period of the time series data on the locations and measured times acquired by the GPS sensor 11 is interpolated, and the activity state of the user is learned as the Hidden Markov Model using the interpolated time series data. Accordingly, even though the missing period exists in the time series data, it is possible to accurately learn the activity state of the user.

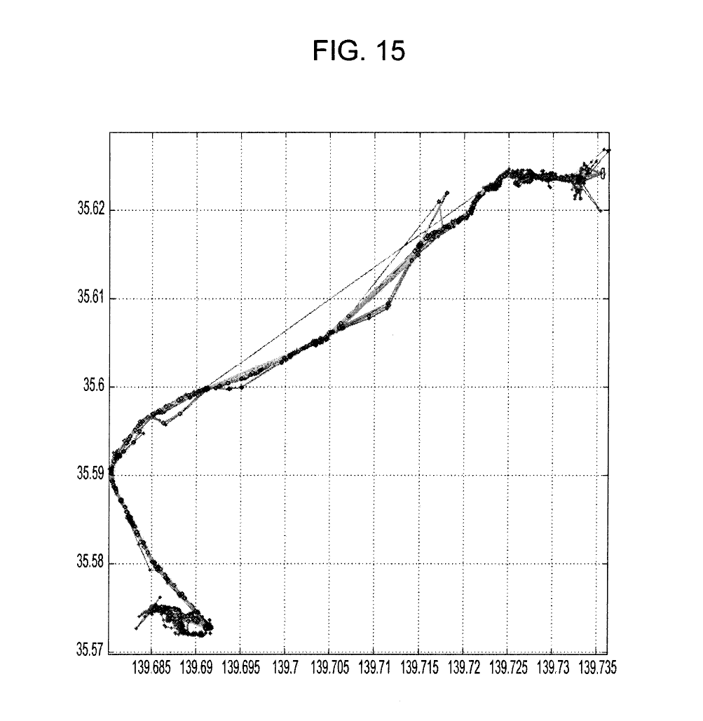

Here, a specific example of the effects of the learning process of the prediction system 1 will be described with reference to FIG. 15.

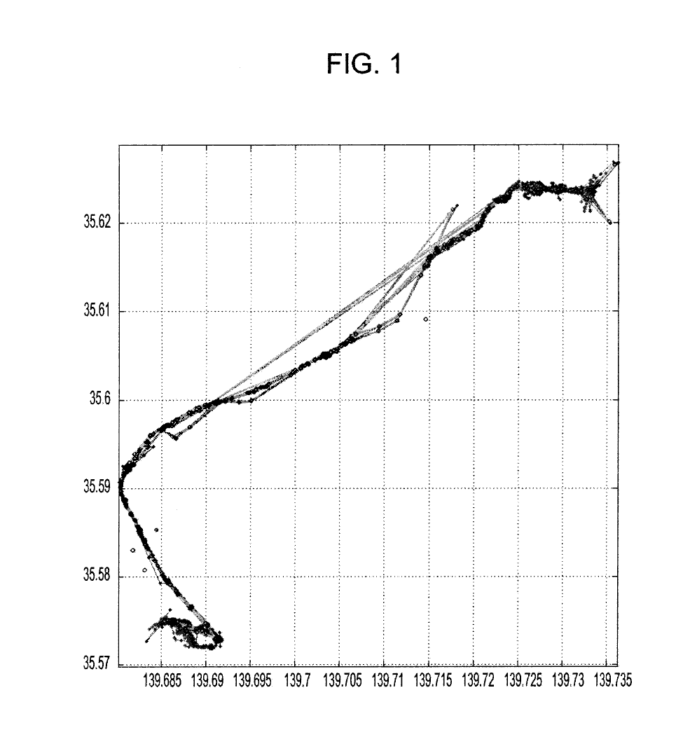

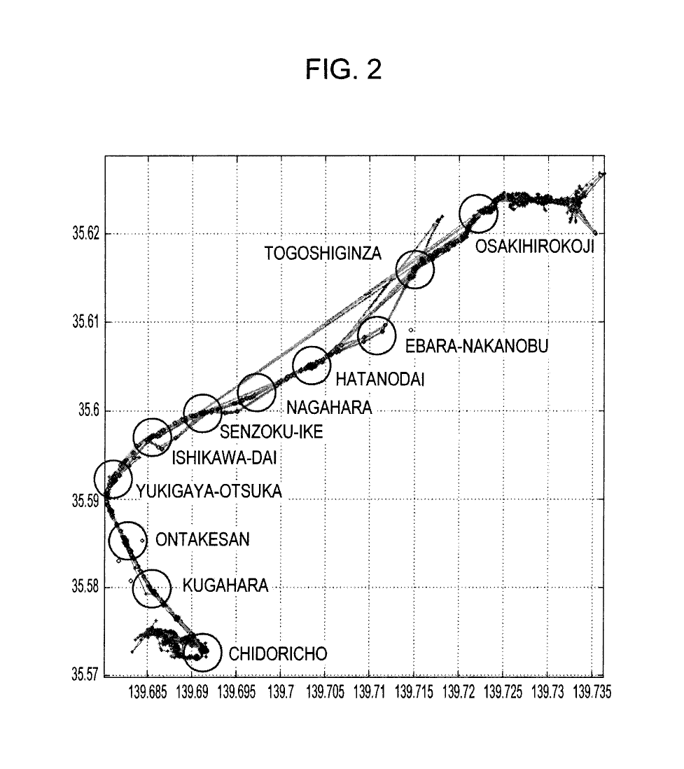

FIG. 15 is a diagram illustrating a result obtained by performing the learning process by the prediction system 1, using the same time series data as in the experiment described with reference to FIGS. 1 and 2. In the learning process at this time, the state likelihood P(sᵢ|xₜ) in step S24 in FIG. 12 is modified using the equation (6).

Referring to FIG. 15 in comparison with FIG. 1, it can be found that the number of state transitions in which state nodes distant from each other are discontinuous is decreased in FIG. 15.

Even though the state likelihoods P(sᵢ|xₜ) for the interpolation location data in the missing period are set to all the same value according to the equation (6), when the forward likelihood αₜ(sᵢ) and the backward likelihood βₜ(sᵢ) are calculated, since state nodes which are close to the interpolated location data are automatically allocated to the interpolated location data, the state transition in which the state nodes are discontinuous is prevented from being learned.

Further, it is possible to obtain approximately the same learning result, even using the above-described equation (7) in modification of the state likelihood P(sᵢ|xₜ). Here, since the reliability of the state likelihood P(sᵢ|xₜ) is further enhanced with the equation (7), it is possible to more accurately learn the user activity model.

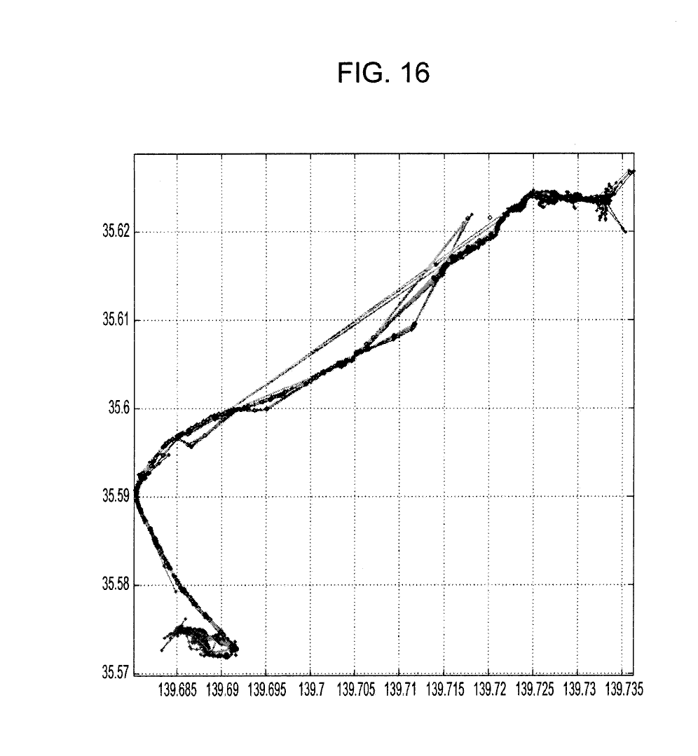

In addition, an example of a learning result in a case where a solution different from that of the prediction system 1 is performed using the same time series data will be described with reference to FIGS. 16 to 18.

FIG. 16 illustrates a result obtained by performing the learning process using the time series data in which data on the same location as the banishing point in the missing period of the time series data is interpolated. That is, FIG. 16 illustrates the result obtained by performing the learning process using the time series data held in the same location as the banishing point during the missing period. According to this method, a plurality of state nodes is allocated around the held location or the self transition probabilities of the state nodes around the held location become higher. Accordingly, the problem of shortage in step numbers up to the destination is solved, and the prediction accuracy of the arrival time to the destination is enhanced. However, compared with FIG. 1, it is difficult to reduce the number of the discontinuous paths, and thus, the process load is increased.

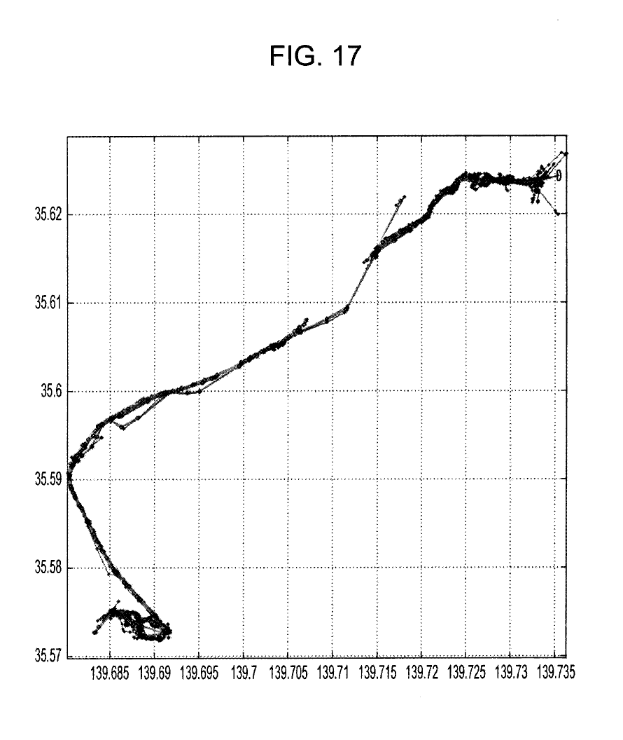

FIG. 17 is a diagram illustrating a learning result in a case where the time series data is divided into time series data of a different type if the missing period is equal to or longer than a predetermined time. That is, FIG. 17 illustrates an example in a case where the time series data is divided if the missing period is two minutes or longer. In this case, since the missing period disappears in the time series data used in learning, it can be found that a commuting path is learned as one path, as shown in FIG. 17. However, in this case, it is necessary to appropriately set the time which becomes a condition in which the time series data is divided.

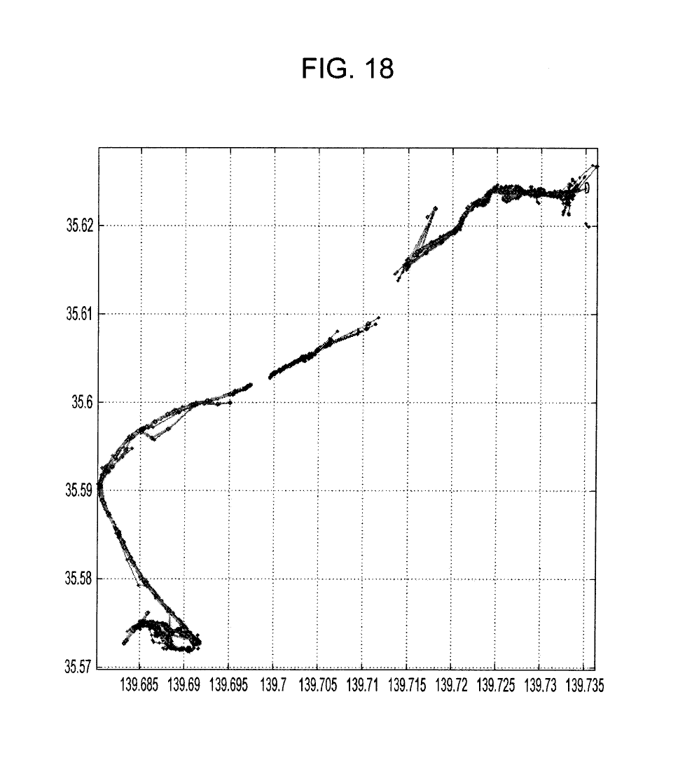

For example, FIG. 18 illustrates a learning result in a case where the time series data is divided if the missing period is equal to or longer than one minute. In this case, since there are too many timings for dividing the time series data, the commuting path is disconnected and is not connected to one line. If the path is disconnected in this way, for example, in a case where the arrival time to the destination is predicted, there is a possibility that the process is terminated without finding even one path for arrival at the destination.

In this respect, in the prediction system 1, it is not necessary to perform adjustment of a variety of parameters, and it is possible to constantly obtain the same learning result with respect to the same time series data.

Further, the prediction system 1 predicts the input arrival probability for the destination and the input paths and arrival times up to the destination using the probabilistic state transition model indicated as the parameters obtained through the learning process, and then presents them to the user.

Accordingly, according to the prediction system 1, it is possible to predict the arrival probability for the destination designated by the user and the paths and arrival times up to the designated destination, to thereby present them to the user. Further, as described above, in the prediction system 1, since the activity model of the user is accurately learned even though a missing portion occurs in the time series data, the prediction accuracy thereof is enhanced.

### 2. Modified Examples

In the above description, the learning process for the time series data of one type has been mainly described, but the present invention can be applied to a learning process for time series data of a plurality of types.

Further, in the above description, the example in which only the time series data on the locations is used in learning of the activity model of the user has been described, but the time series data on the measured times may be also used. However, the measured times do not have any error in the interpolated value, differently from the location data. Accordingly, for example, the calculation equation (7) of the state likelihood P(sᵢ|xₜ) for the interpolation location data may be changed into the following equation (16).

$$P ( {s}_{i} \vert {x}_{t} ) = {[ exp ( - {\sum }_{d = 1}^{2} \frac{{( {x}_{t} ( d ) - {μ}_{si} ( d ) )}^{2}}{( {{σ}_{si} ( d )}^{2} + {{σ}_{t} ( d )}^{2} )} ) ]}^{w 1} \times {[ \frac{1}{\sqrt{2 {{πσ}_{si} ( 3 )}^{2}}} exp ( - \frac{{( {x}_{t} ( 3 ) - {μ}_{si} ( 3 ) )}^{2}}{2 {{σ}_{si} ( 3 )}^{2}} ) ]}^{w 2} \qquad ( 16 )$$

Here, xₜ(1), xₜ(2) and xₜ(3) represent the latitude, the longitude and a measured time of the data xₜ of the time series data at the time t, respectively. Further, μₛᵢ(1) and σₛᵢ(1) represents a center value and a standard deviation of the output probability density function of the latitudes of the states sᵢ. Further, μₛᵢ(2) and σₛᵢ(2) represent a center value and a standard deviation of the output probability density function of the longitudes of the states sᵢ. Further, μₛᵢ(3) and σₛᵢ(3) represent a center value and a standard deviation of the output probability density function of the measured times of the states sᵢ. Further, σₜ(1)² and σₜ(1)² respectively represent dispersion (reliability) of the latitudes, and dispersion (reliability) of the longitudes of the data xₜ of the time series data at the time t. Further, w1 and w2 represent weights, which are set according to the contribution level to a structure of the time series data of each data.

According to the equation (16), only the reliabilities of the latitude and the longitude which are interpolated are reflected to the state probability P(sᵢ|xₜ).

Instead of the equation (16), the equation (6) may be used.

Further, in the above description, the example in which the HMM indicating the activity model of the user is learned using the time series data on the locations has been described, but the embodiment of the present invention can be applied to a case where the HMM is learned from the time series data, regardless of the type of the data.

Further, in a case where sampling intervals of the data are not constant in the period (normal period) other than the missing period of the time series data used in learning, a re-sampling process or the like may be performed so that the sampling intervals become constant.

The series of processes as described above may be performed by hardware or software. In a case where the series of processes is performed by software, a program for forming the software is installed in a computer. Here, the computer includes a computer mounted in an exclusive hardware or a general-purpose personal computer which is installed with a variety of programs to perform a variety of functions.

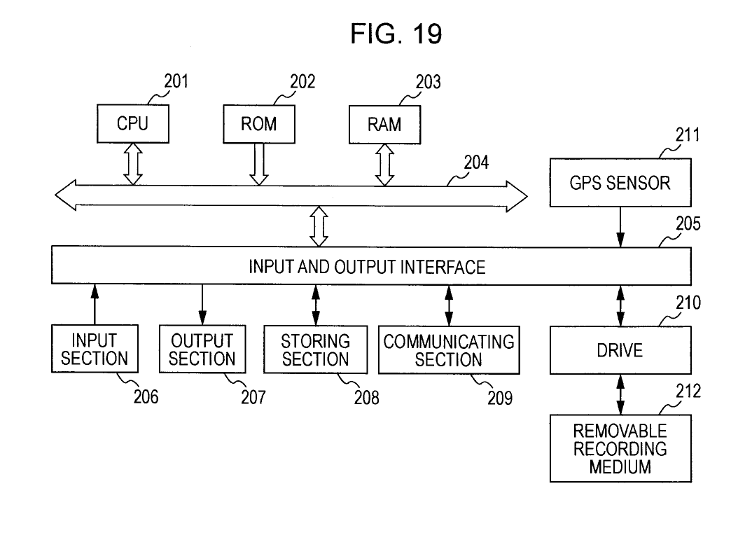

FIG. 19 is a block diagram illustrating a hardware configuration example of the computer which executes the series of processes as described above by programs.

In the computer, a CPU (central processing unit) 201, a ROM (read only memory) 202 and a RAM (random access memory) 203 are connected to each other through a bus 204.

Further, an input and output interface 205 is connected to the bus 204. An input section 206, an output section 207, a storing section 208, a communication section 209, a drive 210 and a GPS sensor 211 are connected to the input and output interface 205.

The input section 206 includes a keyboard, a mouse, a microphone or the like. The output section 207 includes a display, a speaker or the like. The storing section 208 includes a hard disc, a non-volatile memory or the like. The communication section 209 includes a network interface or the like. The drive 210 drives a removable recording medium 212 such as a magnetic disc, an optical disc, a magneto-optical disc, a semiconductor memory or the like. The GPS sensor 211 corresponds to the GPS sensor 11 in FIG. 1.

In the computer with such a configuration, for example, the CPU 201 loads a program stored in the storing section 208 to the RAM 203 through the input and output interface 205 and the bus 204 to be executed, to thereby perform the series of processes as described above.

The program executed by the computer (CPU 201) can be recorded in the removable recording medium 212 which is a package media or the like for supply, for example. Further, the program can be supplied through a wired or wireless transmission medium, such as a local area network, the internet or digital satellite broadcasting.

In the computer, the program can be installed in the storing section 208 through the input and output interface 205, by installing the removable recording medium 212 to the drive 210. Further, the program may be received in the communication section 209, through the wired or wireless transmission medium, and then may be installed in the storing section 208. In addition, the program may be installed in the ROM 202 or the storing section 208, in advance.

The program executed by the computer may be a program in which the procedure is performed in a time series manner in the order as described in this description, or may be a program in which the procedure is performed in parallel or at a necessary timing, for example, when a call is performed.

In this description, the steps disclosed in the flowcharts may be performed in a time series manner in the described order, or may be performed in parallel or at a necessary timing, for example, when the call is performed.

In this description, the system refers to the entire apparatus including a plurality of devices.

The embodiments of the present invention is not limited to the above-described embodiments, but may be variously modified without departing from the spirit of the invention.

The present application contains subject matter related to that disclosed in Japanese Priority Patent Application JP 2009-276691 filed in the Japan Patent Office on Dec. 4, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A learning apparatus comprising:
interpolating means for interpolating data missing in time series data;
estimating means for estimating a Hidden Markov Model from the time series data; and
likelihood calculating means for calculating the likelihood of the estimated Hidden Markov Model,
wherein the likelihood calculating means calculates the likelihood for normal data which does not have missing data and the likelihood for interpolation data which is interpolated data in different conditions and calculates the likelihood of the Hidden Markov Model for the time series data in which the data is interpolated, and
wherein the estimating means updates the Hidden Markov Model so that the likelihood calculated by the likelihood calculating means becomes high.

2. The learning apparatus according to claim 1,
wherein the likelihood calculating means sets the likelihood for the interpolation data lower than the likelihood for the normal data.

3. The learning apparatus according to claim 2,
wherein the interpolating means interpolates, on the basis of first data directly before a missing period in the time series data and second data directly after the missing period in the time series data, data in the missing period, and sets the reliability of the interpolation data at a high level for data which is close to the beginning or end of the missing period and at a low level for data which is distant from the beginning or end of the missing period, and
wherein the likelihood calculating means sets the likelihood of the interpolation data at a low level as the reliability of the interpolation data is low.

4. The learning apparatus according to claim 1,
wherein the likelihood calculating means sets all the likelihoods of respective states of the Hidden Markov Model for the interpolation data to the same value.

5. The learning apparatus according to any one of claims 1 to 4,
wherein the estimating means sets the contribution level of the interpolation data to an observation probability of the Hidden Markov Model lower than the contribution level of the normal data thereto.

6. A learning method performed in a learning apparatus which learns a Hidden Markov Model from time series data, the method comprising the steps of:
interpolating data missing in the time series data;
estimating the Hidden Markov Model from the time series data;
calculating the likelihood of the estimated Hidden Markov Model;
calculating the likelihood for normal data which does not have missing data and the likelihood for interpolation data which is interpolated data in different conditions and calculating the likelihood of the Hidden Markov Model for the time series data in which the data is interpolated, and
updating the Hidden Markov Model so that the calculated likelihood becomes high.

7. A program which causes a procedure to be executed in a computer, the procedure comprising the steps of:
interpolating data missing in the time series data;
estimating the Hidden Markov Model from the time series data;
calculating the likelihood of the estimated Hidden Markov Model;
calculating the likelihood for normal data which does not have missing data and the likelihood for interpolation data which is interpolated data in different conditions and calculating the likelihood of the Hidden Markov Model for the time series data in which the data is interpolated, and
updating the Hidden Markov Model so that the calculated likelihood becomes high.

8. A learning apparatus comprising:
an interpolating section which interpolates data missing in time series data;
an estimating section which estimates a Hidden Markov Model from the time series data; and
a likelihood calculating section which calculates the likelihood of the estimated Hidden Markov Model,
wherein the likelihood calculating section calculates the likelihood for normal data which does not have missing data and the likelihood for interpolation data which is interpolated data in different conditions and calculates the likelihood of the Hidden Markov Model for the time series data in which the data is interpolated, and
wherein the estimating section updates the Hidden Markov Model so that the likelihood calculated by the likelihood calculating section becomes high.
